(19) United States
(12) Patent Application Publication
(10) Pub. No.: US 2011/0199631 A1
(43) Pub. Date: Aug. 18, 2011

(54) AUTOGRAPH SYSTEM

(76) Inventor: Mark A. Healy, Mississauga (CA)

(21) Appl. No.: 12/986,058

(22) Filed: Jan. 6, 2011

Related U.S. Application Data
(60) Provisional application No. 61/304,839, filed on Feb. 16, 2010.

(51) Int. Cl. G06K 15/02; G06F 15/16; G06K 9/00

(52) U.S. Cl. 358/1.14; 709/206; 382/100

(57) ABSTRACT

Apparatus for use with a plurality of marks and by a user is disclosed. The apparatus comprises a storage facility, an interface facility and a delivery facility. The storage facility, in use, is in receipt of mark data records, each of said mark data records being representative of a respective one of said plurality of marks. The interface facility is adapted to permit said user to identify: a selected one of said plurality of marks; and a destination. The delivery facility is adapted to, using the mark data record of the selected mark, deliver a copy of the selected mark to the destination. The destination can be an e-mail address, the copy can be delivered by means of an electronic file and the mark can be a signature.

### CROSS-REFERENCE TO RELATED APPLICATION

This application claims priority of U.S. Provisional Patent Application Ser. No. 61/304,839 filed Feb. 16, 2010, which is incorporated herein by reference.

### FIELD OF THE INVENTION

The present invention relates to the field of memorabilia.

### BACKGROUND OF THE INVENTION

Many persons find enjoyment in the collection of autographs, and autographs accordingly can command substantial sums in the free market. As a result, fraud is a significant problem in the memorabilia field.

### SUMMARY OF THE INVENTION

Apparatus for use with a plurality of marks and by a user forms one aspect of the invention. The apparatus comprises a storage facility, an interface facility and a delivery facility. The storage facility, in use, is in receipt of mark data records, each of said mark data records being representative of a respective one of said plurality of marks. The interface facility is adapted to permit said user to identify a selected one of said plurality of marks and a destination. The delivery facility is adapted to, using the mark data record of the selected mark, deliver a copy of the selected mark to the destination.

According to another aspect of the invention, the destination can be an e-mail address.

According to another aspect of the invention, the copy can be delivered by means of an electronic file.

According to another aspect of the invention, the mark can be a signature.

According to another aspect of the invention, the storage facility, in use, can be in receipt of image data records, each of said image data records being representative of a respective image.

According to another aspect of the invention, an image data record can be associated with each mark data record and the copy of the selected mark can be delivered in conjunction with the image of which the image data record associated with the mark data record representative of said selected mark is representative.

According to another aspect of the invention: the interface facility can be further adapted to permit said user to identify a selected one of the image data records; and the copy of the selected mark can be delivered in conjunction with the image of which the selected image data record is representative, the copy and the image collectively defining a view.

According to another aspect of the invention, the view can have embedded therein an optical watermark to permit optical authentication.

According to another aspect of the invention, the electronic file can carry the copy, the copy can be enabled with one or more digital signature fields and the copy can be authenticated using the digital signature fields.

According to another aspect of the invention, the electronic file can carry the copy and the copy can be provided in a format which is not readily susceptible to digital reproduction and which is adapted to permit only a single print to be made.

According to another aspect of the invention, the interface facility can be further adapted to permit said user to provide a caption and the copy of the selected mark can be delivered in conjunction with the caption.

A method, for use with a plurality of marks and by a user, forms another aspect of the invention. The method comprises the steps of: receiving mark data records, each of said mark data records being representative of a respective one of said plurality of marks; providing an interface facility adapted to permit a user to identify a selected one of said plurality of marks and a destination; and, using the mark data record of the selected mark, delivering a copy of the selected mark to the destination.

Other advantages, features and characteristics of the present invention will become more apparent upon consideration of the following detailed description and the appended claims with reference to the attached drawings, the latter being briefly described hereinafter.

### BRIEF DESCRIPTION OF THE DRAWINGS

FIG. 1 is a view showing a representation of the data structure of the storage facility according to the exemplary embodiment;

FIG. 2 is a view of a computer screen showing a mark selection page generated by the interface facility of the exemplary embodiment;

FIG. 3 is a view of a computer screen showing an image selection page generated by the interface facility of the exemplary embodiment;

FIG. 4 is a view of a computer screen showing a caption capture page generated by the interface facility of the exemplary embodiment; and

FIG. 5 is a view of a computer screen showing a destination capture page generated by the interface facility of the exemplary embodiment.

### DETAILED DESCRIPTION

The exemplary embodiment of the present invention is hereinafter described with reference to the attached figures.

As an initial matter, the invention should be understood as being for use: by a user; with a plurality of marks, specifically in this case, signatures of celebrities; and with a plurality of images, in this case, likenesses of celebrities.

The user in this embodiment can be any person who desires to facilitate the procurement of a celebrity autograph and has access to the Internet.

The apparatus itself in this embodiment takes the form of a program resident on a server which has access to the Internet, and comprises three main functional components: a storage facility; an interface facility; and a delivery facility.

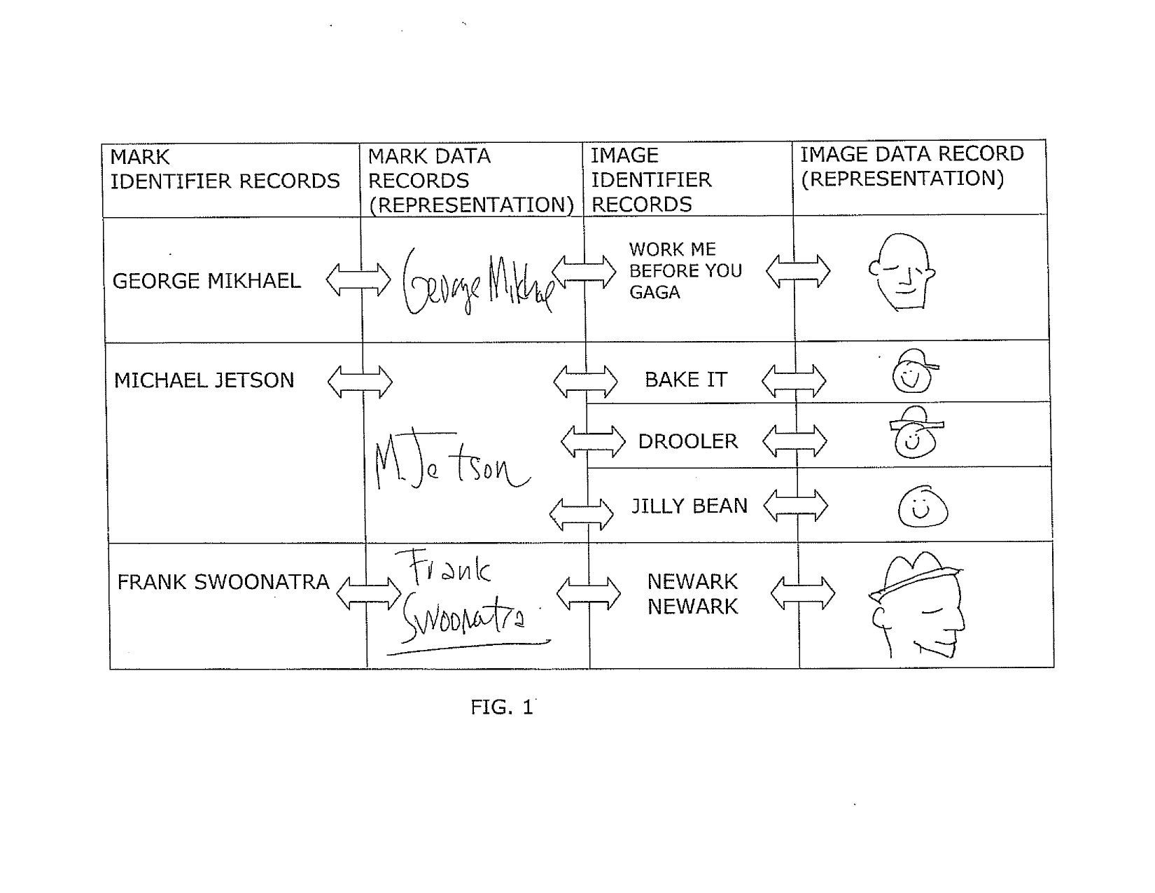

The storage facility, in use, is in receipt of mark data records, mark identifier records, image identifier records and image data records. The exemplary data structure is described hereinafter, and is shown representationally in FIG. 1.

The mark identifier records will each be seen to be a name, in this case, the fictional celebrities GEORGE MIKHAEL, MICHAEL JETSON and FRANK SWOONATRA.

Each of the mark identifier records is associated with a respective mark data record, the association being indicated by the double-ended arrows.

Each mark data record, in the exemplary embodiment, is a collection of digital data which is representative of a respective one of the plurality of signatures/marks; in FIG. 1, the representation of the marks, i.e. the signatures, rather than the digital data, is shown for simplicity.

Each of the image identifier records is associated with a respective one of the mark data records. In the case of the fictional celebrity MICHAEL JETSON, there are three associated image identifier records, BAKE IT, DROOLER and JILLY BEAN; in the case of GEORGE MIKHAEL and FRANK SWOONATRA, only a single associated image identifier record is shown.

Each image data record, in the exemplary embodiment, is associated with a respective one of the image identifier records and takes the form of a collection of digital data which is representative of a respective one of the plurality of images; in FIG. 1, the representation of the images is shown for simplicity. In this application, the images are each a likeness of the associated celebrity.

The interface facility is adapted to permit said user to: identify a selected one of said plurality of marks; identify a destination; identify a selected one of the image data records; and permit said user to provide a caption.

The interface facility of the exemplary embodiment allows for the above functionality through an Internet portal, i.e. the interface facility generates a series of web pages which capture user information.

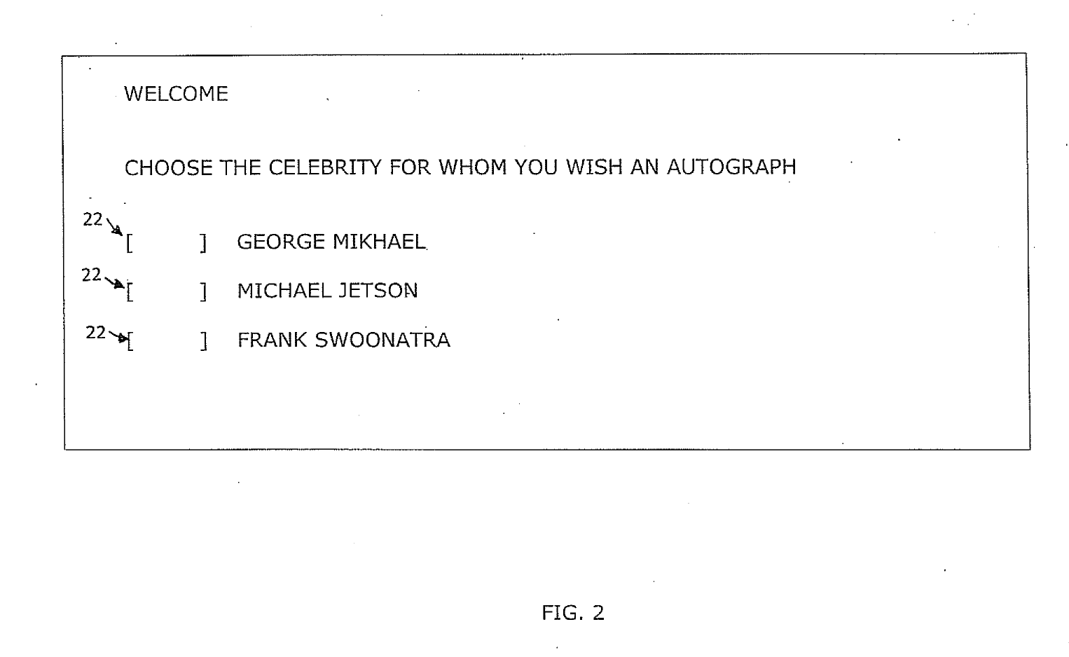

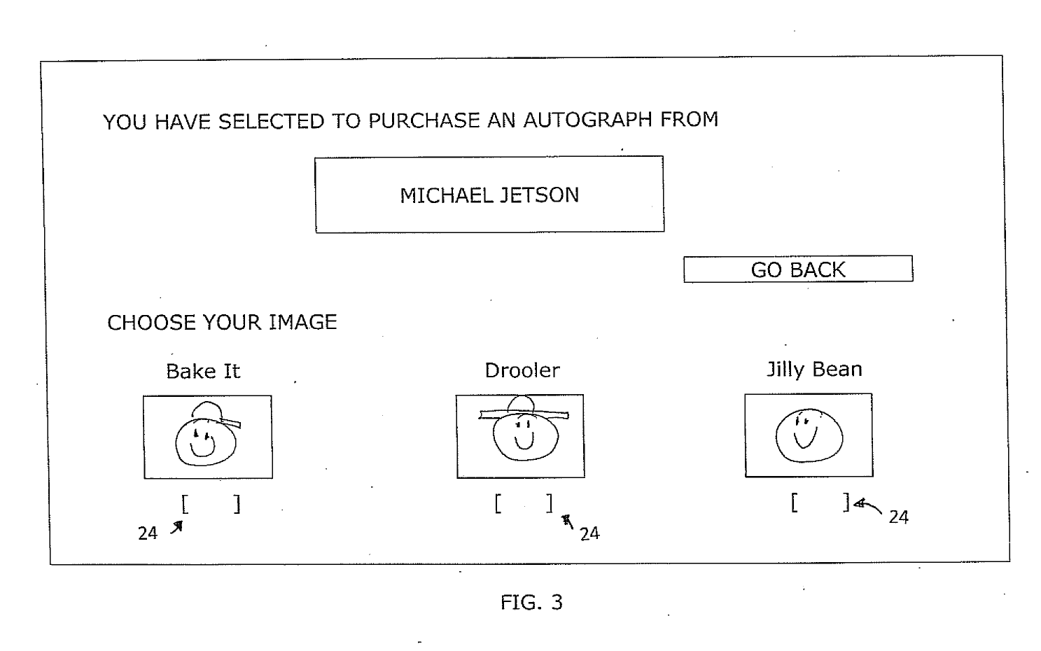

FIG. 2 shows a representative mark selection page. Arrival at this page by a user prompts the interface to read and reproduce, in list form, the mark identifier records, and to prompt the user to make a selection from amongst the list using one of three selection boxes 22. A selection prompts the interface utility to produce an image selection page, as shown in FIG. 3.

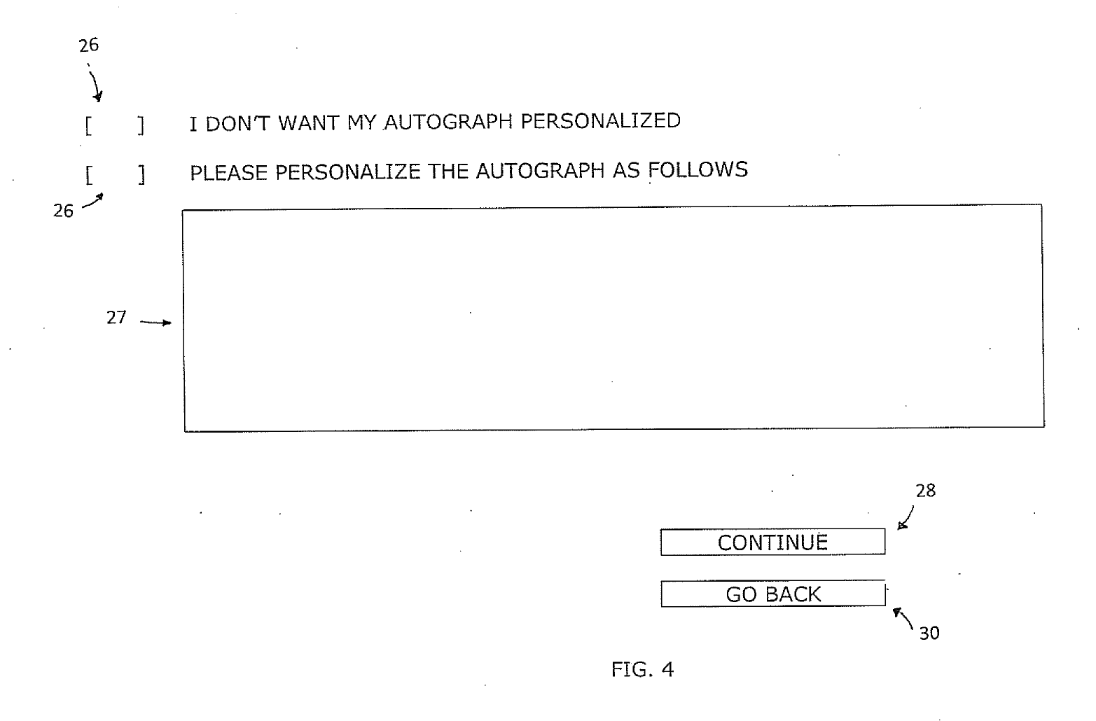

On the image selection page, the interface reads and reproduces the image identifier records associated with the selected mark identifier record, displays the images associated with these image identifier records, and prompts the user to make a selection amongst the image data records using one of three selection boxes 24. A selection prompts the interface utility to produce a caption capture page, as shown in FIG. 4.

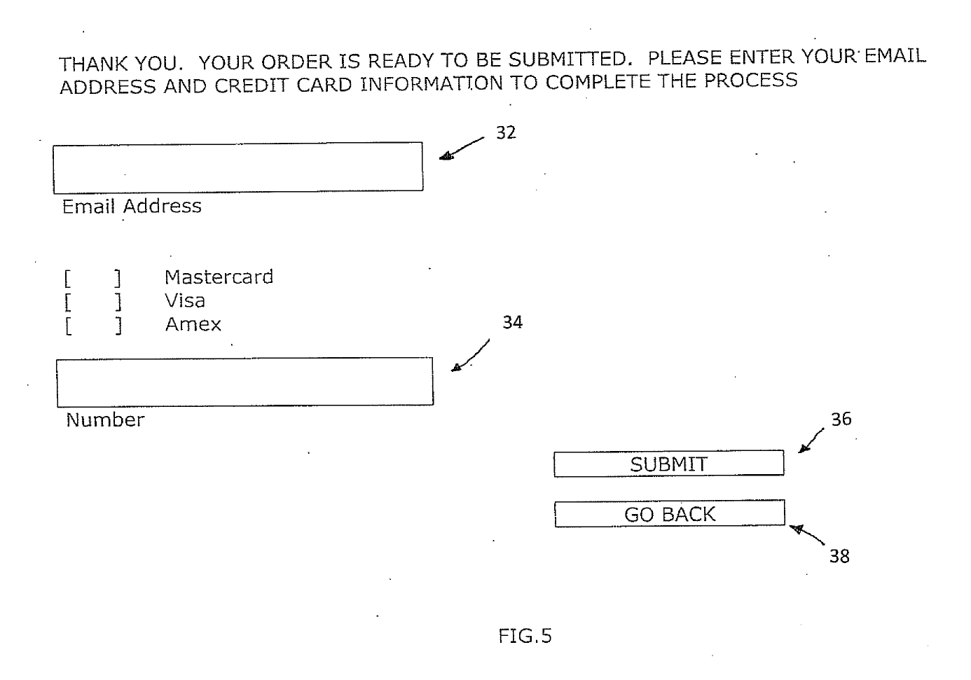

On the caption capture page, the interface permits the user to indicate whether or not captioning is desired using one of two selection boxes 26, and if so, to input a desired caption in text capture box 27. Once the caption has been completed, or the opportunity refused, the user can continue by selection of a CONTINUE box 28, to traverse to a destination capture page, as shown in FIG. 5. A GO BACK box 30 allows the user to return to the page of FIG. 3 and change selections.

On the destination capture page, the user is prompted to enter an email address and payment information in appropriate text input boxes 32,34. Selection of the SUBMIT button 36 on this page initiates the delivery facility. The GO BACK button 38 on this page returns the user to the page shown in FIG. 4 and change selections.

The delivery facility creates a view composed of the image of which the selected image data record is representative, overlaid with the mark of which the selected mark data record is representative as well as any caption entered, and delivers the view to the email address specified. In the exemplary embodiment, the view is in the form of an electronic file, specifically, a live .pdf file enabled with digital signature fields, and further carries an optical watermark. The signature field enablement permits the recipient to authenticate the mark embodied within the view. The live nature of the .pdf file renders the file resistant to copying, and further adapts the file such that, normally, only a single print image can be produced therefrom. The optical watermark permits the single print permitted to be authenticated optically at a later date.

Software for creating live .pdf files enabled with digital signature fields and optical watermarks is commercially available. Suitable programs for the former are those sold by Softpro North America, Inc. under the trade-mark Softpro and sold by DocuSign Inc. under the trade-mark DocuSign. The underlying functionality of the program Softpro product is driven by a program sold by Adobe Inc. under the trade-mark LiveCycle. Programs for creating optical watermarks are widely available in the open commercial marketplace.

The system has attractiveness to fans of memorabilia in that it provides a ready mechanism for persons in remote areas to secure approved memorabilia, customized to their liking.

For celebrities, the system has attractiveness in that, inter alia, it enables celebrities to provide customized autographs to fans, without the attendant inconvenience associated with physical signatures.

Whereas but a single exemplary embodiment is herein described, it will be evident that numerous changes are possible.

For example, whereas in the exemplary embodiment, a plurality of image identifier records can be associated with each mark data record, this is not essential. A useful arrangement could include, for each mark identifier record, a mark data record and an image data record, all associated with one another. As well, the image data records themselves could also be omitted altogether, and replaced with, for example, a blank page.

Further, whereas captioning is provided in the exemplary embodiment, this could also be omitted.

As well, whereas the delivery facility of the exemplary embodiment delivers the image electronically, this is not essential; the destination could equally be a mailing address, and the image could be delivered in print.

Further, whereas the exemplary interface is embodied by an Internet portal, this is also not necessary; the system could, for example, be implemented by telephone, with selection pages being sent by SMS or MMS messaging.

Yet further, whereas apparatus is described, persons of ordinary skill in the art will readily appreciate that the invention could equally be expressed as a method, and this also forms part of the invention.

Moreover, whereas in the exemplary embodiment, an optical watermark is specified, to permit authentication of the printed view, this level of authentication is not required. As well, even if authentication of the printed view is desired, the optical watermark is not essential: other identifiers, such as visible bar codes or UPC codes, could be employed.

Accordingly, the invention should be understood as limited only by the accompanying claims, purposively construed.

1. Apparatus for use with a plurality of marks and by a user, said apparatus comprising:
a storage facility which, in use, is in receipt of mark data records, each of said mark data records being representative of a respective one of said plurality of marks;
an interface facility adapted to permit said user to identify:
a selected one of said plurality of marks; and
a destination
a delivery facility adapted to, using the mark data record of the selected mark, deliver a copy of the selected mark to the destination.

2. Apparatus according to claim 1, wherein the destination is an e-mail address.

3. Apparatus according to claim 1, wherein the copy is delivered by means of an electronic file.

4. Apparatus according to claim 1, wherein the mark is a signature.

5. Apparatus according to claim 4, wherein the storage facility, in use, is in receipt of image data records, each of said image data records being representative of a respective image.

6. Apparatus according to claim 5, wherein an image data record is associated with each mark data record and the copy of the selected mark is delivered in conjunction with the image of which the image data record associated with the mark data record representative of said selected mark is representative.

7. Apparatus according to claim 6, wherein:
the interface facility is further adapted to permit said user to identify a selected one of the image data records; and
the copy of the selected mark is delivered in conjunction with the image of which the selected image data record is representative, the copy and the image collectively defining a view.

8. Apparatus according to claim 6, wherein the view has embedded therein an optical watermark to permit optical authentication.

9. Apparatus according to claim 8, wherein the electronic file carries the copy, the copy is enabled with one or more digital signature fields and the copy can be authenticated using the digital signature fields.

10. Apparatus according to claim 8, wherein the electronic file carries the copy and the copy is provided in a format which is not readily susceptible to digital reproduction and which is adapted to permit only a single print to be made.

11. Apparatus according to claim 10, wherein:
the interface facility is further adapted to permit said user to provide a caption; and
the copy of the selected mark is delivered in conjunction with the caption.

12. Method for use with a plurality of marks and by a user, said method comprising the steps of:
receiving mark data records, each of said mark data records being representative of a respective one of said plurality of marks;
providing an interface facility adapted to permit a user to identify: a selected one of said plurality of marks; and a destination
using the mark data record of the selected mark, delivering a copy of the selected mark to the destination.
